(19) United States
(12) Patent Application Publication
(10) Pub. No.: US 2026/0113688 A1
(43) Pub. Date: Apr. 23, 2026

(54) BACKUP CONNECTIVITY FOR TROUBLESHOOTING

(71) Applicant: Cisco Technology, Inc., San Jose, CA (US)

(72) Inventors: Jerome Henry, Pittsboro, NC (US); Domenico Ficara, Essertines-sur-Yverdon (CH); Ugo Mario Campiglio, Morges (CH); Amine Choukir, Lausanne (CH); Leo Caldarola, Morrens (CH); Pascal Thubert, Roquefort-les-Pins (FR)

(73) Assignee: Cisco Technology, Inc., San Jose, CA (US)

(21) Appl. No.: 18/923,833

(22) Filed: Oct. 23, 2024

(51) Int. Cl. H04W 40/24; H04W 40/12

(52) U.S. Cl. CPC H04W 40/246; H04W 40/12

(57) ABSTRACT

Alternative communications techniques for troubleshooting may be provided. Using alternative communications techniques for troubleshooting can include sending an alternative communications advertisement frame to a client, the alternative communications advertisement frame identifying an alternative connection for communicating with the client. An alternative communications troubleshooting frame is then received from the client via the alternative connection, the alternative communications troubleshooting frame comprising troubleshooting information associated with a connection issue of a wireless network. The troubleshooting information is sent to a network device.

### TECHNICAL FIELD

The present disclosure relates generally to providing alternative communications techniques for troubleshooting.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for supporting alternative communications techniques for troubleshooting in accordance with aspects of the present disclosure.

FIG. 2 is a block diagram of an alternative communications advertisement frame in accordance with aspects of the present disclosure.

FIG. 3 is a block diagram of an alternative communications troubleshooting frame in accordance with aspects of the present disclosure.

FIG. 4 is a block diagram of an alternative communications request frame in accordance with aspects of the present disclosure.

FIG. 5 is a signal diagram of a signal process for supporting alternative communications techniques for troubleshooting in accordance with aspects of the present disclosure.

FIG. 6 is a flow chart of a method for supporting alternative communications techniques for troubleshooting in accordance with aspects of the present disclosure.

FIG. 7 is a block diagram of a computing device in accordance with aspects of the present disclosure.

FIG. 8 is a block diagram of a communications device in accordance with aspects of the present disclosure.

### DETAILED DESCRIPTION

### Overview

Alternative communications techniques for troubleshooting may be provided. Using alternative communications techniques for troubleshooting can include sending an alternative communications advertisement frame to a client, the alternative communications advertisement frame identifying an alternative connection for communicating with the client. An alternative communications troubleshooting frame is then received from the client via the alternative connection, the alternative communications troubleshooting frame comprising troubleshooting information associated with a connection issue of a wireless network. The troubleshooting information is sent to a network device.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Troubleshooting wireless network (e.g., Wi-Fi) issues can be challenging. For example, the troubleshooting party may only have a partial, one-sided view of the state of the environment. An Access Point (AP) can log elements that include operational data (e.g., the time of a client message, the Received Signal Strength Indicator (RSSI) associated with the client, the Signal-to-Noise-Ratio (SNR), etc.) and standard data (e.g., the details of the client frame and the various Information Elements (IEs)). A client can typically perform the same operations. However, each side typically only logs the elements relevant to its view of the issue. Thus, the client may not utilize information the AP has when troubleshooting, and the AP may not utilize information the AP has when troubleshooting.

If there is a is a connection failure, the AP and client may not be able to communicate to share information for troubleshooting the issue. The devices therefore will not be able to exchange logs or signal that there is an issue. Troubleshooting with only information from one device may be impossible or prohibitively difficult. Thus, alternative backup communication techniques may be utilized for exchanging information for troubleshooting, even when the primary connection fails. For example, a client can provide troubleshooting information to one or more network devices via a different communication technique in an attempt to restore access to the wireless network.

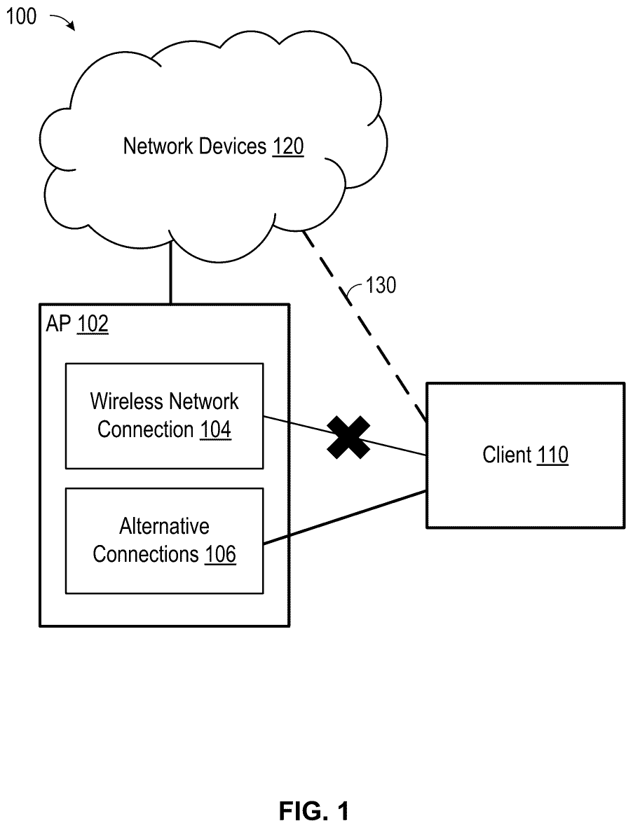

FIG. 1 is a block diagram of an operating environment 100 for supporting alternative communications techniques for troubleshooting. The operating environment 100 includes an AP 102 with a wireless network connection 104 and alternative connections 106. The AP 102 can enable devices to access the wireless network, such as via the wireless network connection 104. The wireless network connection 104 can include one or more antennas, wireless chipsets, processing units, and/or the like to communicate with client devices and other network devices via the wireless network, such as to facilitate communication between clients and other network devices. The alternative connections 106 may be connections for any alternative communication techniques, such as using another Service Set Identifier (SSID) on a different channel or band, cellular communication (e.g., 4G, 5G, etc.), short-range wireless communication, low-rate wireless personal area network communication methods, low-power, wide-area networking communication methods, and/or the like. The alternative connections 106 can include one or more antennas, wireless chipsets, processing units, and/or the like to communicate with client devices and other network devices via the alternative communication techniques. In certain embodiments, the wireless network connection 104 and the alternative connections 106 both utilize shared components for communicating with clients via the various communication techniques.

The operating environment 100 also includes a client 110 and network devices 120. The client 110 can be any device that utilizes or attempts to utilize the wireless network, such as a smart phone, a personal computer, a laptop, a tablet, a server, an Internet-of-Things device, etc. The network devices 120 can be any devices connected to the wireless network, such as remote servers, other clients, etc.

The client 110 can communicate with the AP 102 via the wireless network connection 104 to communicate with one or more of the network devices 120. However, the client 110 may fail to connect to the AP 102 for various reasons, such as AP 102 configuration issues and/or other issues, client 110 configuration issues and/or other issues, security encryption mismatches, network driver issues, and/or the like. If there is a is a connection failure with the wireless network connection 104, the AP 102 and the client 110 may not be able to communicate to share information for troubleshooting the issue. The AP 102 and the client 110 therefore will not be able to exchange logs or notify the other device of the issue, and troubleshooting with only information from one device may be impossible or prohibitively difficult. The AP 102 and the client 110 may utilize new frames and methods for performing troubleshooting via the alternative connection 106, as will be further described herein. Additionally, the client 110 can optionally communicate directly with a network device 120 via direct connection 130 to report troubleshooting information in certain embodiments. There may be a different number of devices in the operating environment 100 in other embodiments, such as additional APs, additional clients, one or more controllers, etc.

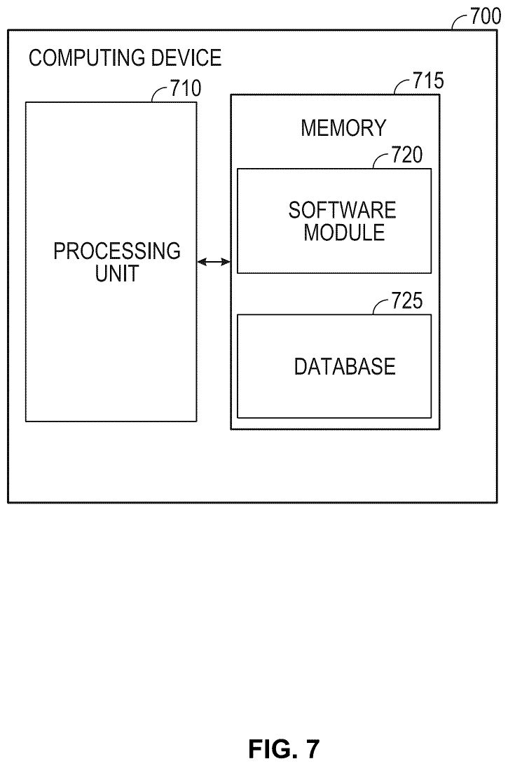

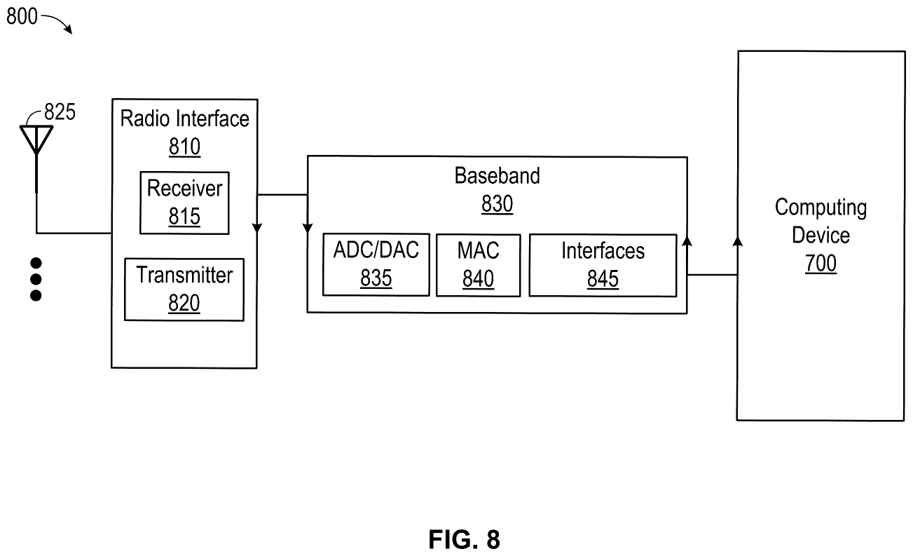

The elements described above of the operating environment 100 (e.g., the AP 102, the client 110, the network devices 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 7 and 8, the elements of the operating environment 100 may be practiced in a computing device 700 and/or communications device 800.

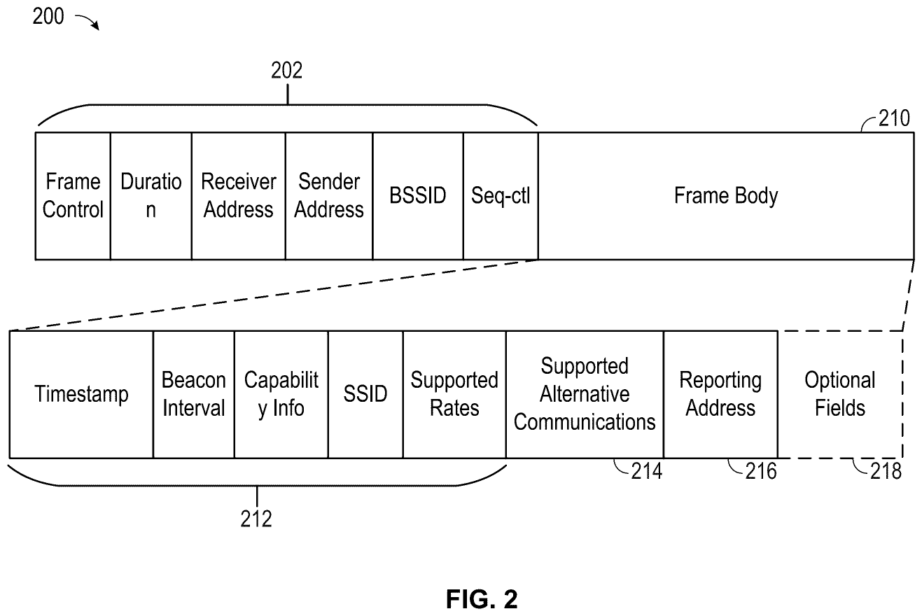

FIG. 2 is a block diagram of an alternative communications advertisement frame 200. The AP 102 can send the alternative communications advertisement frame 200 to devices (e.g., the client 110) to indicate one or more alternative communication methods the AP 102 can use (i.e., alternative connections 106). Devices, such as the client 110, may then utilize one or more of the available alternative connections 106, for example when troubleshooting communication issues associated with the wireless network connection 104.

The alternative communications advertisement frame 200 includes header fields 202 and a frame body 210. The header fields 202 can include any number and combination of fields for including information about the alternative communications advertisement frame 200, such as control information, source and destination addresses (e.g., Media Access Control (MAC) addresses), error checking codes, sequencing information, and/or the like. For example, the header fields 202 can include a frame control field, a duration field, a receiver address field, a sender address field, a Service Set Identifier (SSID) and/or a Basic SSID (BSSID) field, a sequence control field, and/or the like.

The frame body 210 includes body header fields 212, a supported alternative communications field 214, a reporting address field 216, and optional fields 218. The body header fields 212 can include any number of fields including information about the wireless network, the AP 102, and/or the like. For example, the body header fields 212 can include a timestamp field enabling synchronization between devices in a Basic Service Set (BSS), a beacon interval field announcing the existence of the wireless network and ability to associate with the AP 102, a capability information field advertising the wireless network's capabilities, a SSID field, a supported rates field specifying the supported data rates, address fields, and/or the like.

The supported alternative communications field 214 can indicate the one or more alternative connections 106 the AP 102 supports and devices can use. The supported alternative communications field 214 can include information for each of the alternative connections 106, such as connection capabilities and requirements (e.g., data rates, range, energy requirements, standards, max payload, etc.). The reporting address field 216 includes an address, such as a Uniform Resource Locator (URL), to communicate with a network device 120 when troubleshooting. The reporting address field 216 can also include characteristics such as the max payload per device, the interval, etc. A device can then communicate with the network device 120 via a different communication method to perform troubleshooting or otherwise report issues with the wireless network connection 104. For example, the client 110 can communicate with a network device 120 using the direct connection 130. In some embodiments, the alternative communications advertisement frame 200 may contain only the supported alternative communications field 214 or the reporting address field 216 depending on the resources available, the reason for sending the alternative communications advertisement frame 200 (e.g., in response to a request by the client 110 for identification of the alternative connections 106), and/or the like. The optional fields 218 can include any optional fields that are present, such as one or more parameter set fields, a Traffic Indication Map field, a Delivery Traffic Indication Map field, a Quiet field, a Transmit Power Control field, an Extended Rate Physical Layer field, and/or the like.

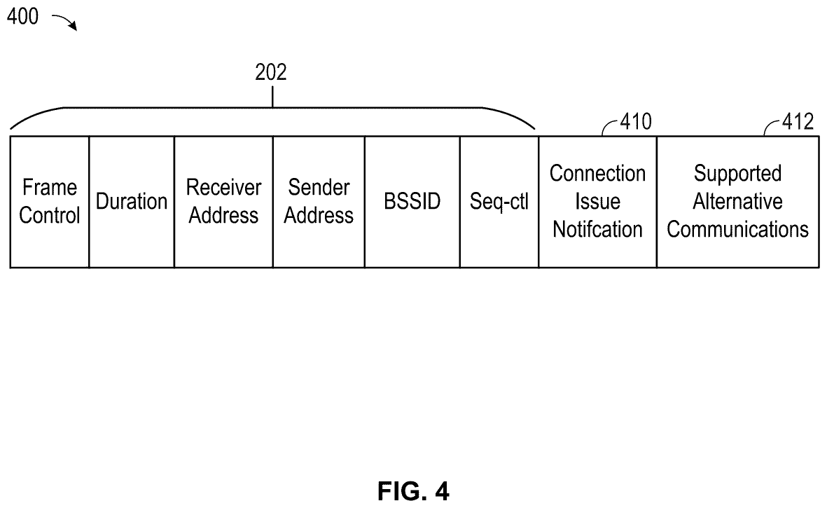

The AP 102 can send the alternative communications advertisement frame 200 at various times. In embodiments, the AP 102 includes the alternative communications advertisement frame 200 in beacons the AP 102 transmits to advertise to clients the wireless network and the AP's 102 availability for association. In other embodiments, the AP 102 includes the alternative communications advertisement frame 200 in a probe response during the association process. The AP 102 can also send the alternative communications advertisement frame 200 in response to a request for identification of available alternative connections 106, as will be described in more detail herein with respect to FIG. 4. The alternative communications advertisement frame 200 can include additional elements in certain embodiments, such as a Frame Check Sequence (FCS) field.

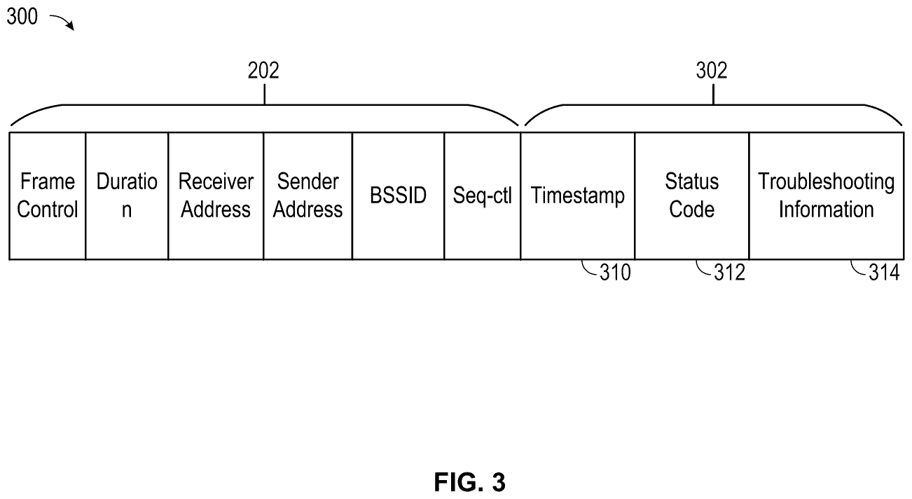

FIG. 3 is a block diagram of an alternative communications troubleshooting frame 300. Devices such as the client 110 can send the alternative communications troubleshooting frame 300 via one or more alternative connections 106 to perform troubleshooting or otherwise diagnose connection issues, report connection issues, correct connection issues, and/or the like associated with the wireless network connection 104. For example, the client 110 may determine the available alternative connections 106 after receiving an alternative communications advertisement frame 200 from the AP 102. When the client 110 has a connection issue associated with the wireless network connection 104 and therefore cannot communicate with the AP 102 or other devices via the wireless network connection 104, the client 110 sends information associated with the connection issue via the alternative communications troubleshooting frame 300 over one or more alternative connections 106.

The alternative communications troubleshooting frame 300 includes header fields 202 and a troubleshooting frame body 302. The header fields 202 can include any number and combination of fields for including information about the alternative communications troubleshooting frame 300. The header fields 202 of the alternative communications advertisement frame 200 and the alternative communications troubleshooting frame 300 may vary.

The troubleshooting frame body 302 includes a timestamp field 310, a status code field 312, and a troubleshooting information field 314. The timestamp field 310 can include information indicating the time the connection issue started. The status code field 312 can include information indicating a status code associated with the connection issue. The troubleshooting information field 314 can include information associated with the connection issue, such as the address of the client 110, the address of the AP 102, characteristics of the wireless network connection 104, the BSSID, and/or the like. If the client 110 has identified multiple connection issues, the timestamp field 310 can indicate the time each connection issue started, the status code field 312 can indicate each status code for each connection issue, and the troubleshooting information field 314 can include information for each connection issue. The troubleshooting frame body 302 can include additional timestamp fields, status code fields, and troubleshooting information fields for each additional connection issue in other embodiments. In certain embodiments, the troubleshooting frame body 302 includes one or more header fields, such as the header fields 202, and/or optional fields, such as the optional fields 218. The alternative communications troubleshooting frame 300 can include additional elements in certain embodiments, such as a FCS field, frame body header elements, etc.

The AP 102 can receive the alternative communications troubleshooting frame 300 via the alternative connections 106. In certain embodiments, the AP 102 attempts to diagnose and fix the connection issue, for example using the information received via the alternative communications troubleshooting frame 300 and the information the AP 102 has collected. The AP 102 can also send the information in the alternative communications troubleshooting frame 300 and/or information the AP 102 has collected to one or more devices of the network devices 120. For example, the AP 102 can send the information in the alternative communications troubleshooting frame 300 and/or information the AP 102 has collected to a network management platform so the platform can diagnose and fix the connection issue. The AP 102 can also include the timestamp when the AP 102 received the alternative communications troubleshooting frame 300 when sending information to a network device 120.

FIG. 4 is a block diagram of an alternative communications request frame 400. In some embodiments, the client 110 may not know the available alternative connections 106. For example, the AP 102 may not send the alternative communications troubleshooting frame 300 when advertising the wireless network or during association. Thus, the client 110 and/or other devices can send the alternative communications request frame 400 to request the AP 102 to identify the available alternative connections 106.

The alternative communications request frame 400 includes header fields 202, a connection issue notification field 410, and a client supported alternative communications field 412. The header fields 202 include any number and combination of fields for including information about the alternative communications troubleshooting frame 300. The header fields 202 of the alternative communications advertisement frame 200, the alternative communications troubleshooting frame 300, and the alternative communications request frame 400 may vary.

The connection issue notification field 410 includes information indicating the device sending the alternative communications request frame 400 has a connection issue. The client supported alternative communications field 412 includes a request for the receiving device (e.g., the AP 102) to respond with supported alternative communications (e.g., the alternative connections 106) and identifies the alternative communication methods the device (e.g., the client 110) can use. The AP 102 may respond with an alternative communications advertisement frame 200 or otherwise begin communicating with the device via one of the client supported alternative communication methods as indicated by the client supported alternative communications field 412. Additionally, the AP 102 may optionally only include alternative connections 106 that the client 110 supports in the supported alternative communications field 214 because notifying the client 110 of alternative connections 106 the client 110 cannot use is a waste of resources.

In certain embodiments, the alternative communications request frame 400 only includes the client supported alternative communications field 412, and the AP 102 can assume there is a connection issue when receiving the alternative communications request frame 400. In other embodiments, the client 110 may send the alternative communications request frame 400 before there is a connection issue, so the AP 102 does not need to be alerted that there is a connection issue via the alternative communications request frame 400. The alternative communications request frame 400 can include additional elements in certain embodiments, such as a FCS field, frame body header elements, etc.

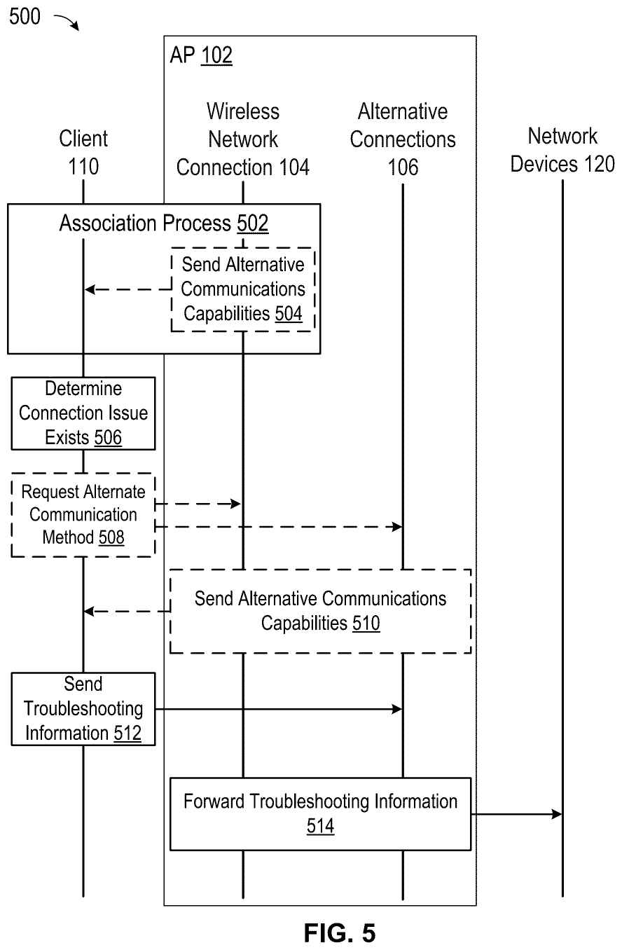

FIG. 5 is a signal diagram of a signal process 500 for supporting alternative communications techniques for troubleshooting. The signal process 500 is between the client 110, the AP 102, and one or more of the network devices 120. The signal process 500 can start with an association process 502. The association process 502 can include any association operations for the client 110 to associate to the AP 102. For example, the client 110 and the AP 102 exchange a probe request, a probe response, authentication frames, an association request, an association response, and/or the like. During the association process 502, the AP 102 can optionally send alternative communication capabilities in operation 504. For example, the AP 102 sends an alternative communications advertisement frame 200 identifying the alternative connections 106 in beacons advertising the wireless network, in a probe response, and/or the like.

Once the client 110 and the AP 102 complete the association process 502, the client 110 can communicate with the AP 102 via the wireless network connection 104 to use and communicate via the wireless network. At some time after the client 110 associates to the AP 102, the client 110 can determine a connection issue exists in operation 506. Thus, the client 110 may not be able to communicate with the AP 102 or otherwise access the wireless network via the wireless network connection 104.

If the client 110 did not receive the alternative communications capabilities previously, such as during the association process 502, the client 110 can optionally request to use alternative communication method in operation 508. For example, the client 110 can send an alternative communications request frame 400 to the AP 102. The client 110 can attempt to send the alternative communications request frame 400 via the wireless network connection 104 if the connection issue still enables the AP 102 to receive from the client via the wireless network connection 104 and/or via one or more alternative connections 106. For example, the client 110 can try sending the alternative communications request frame 400 via various alternative communication methods until the client 110 receives a response from the AP 102.

In response to the client 110 requesting an alternative communication method in operation 508, the AP 102 can respond with alternative communications capabilities in operation 510. For example, the AP 102 sends an alternative communications advertisement frame 200 or otherwise indicates to the client 110 to use the alternative connections 106. The AP 102 can send the alternative communications advertisement frame 200 via the wireless network connection 104 if the connection issue still allows the client 110 to receive via the wireless network connection 104 and/or via one or more of the alternative connections 106. For example, the AP 102 can select an alternative connection 106 based on the client supported alternative communications field 412 of the alternative communications request frame 400 received in operation 508.

In operation 512, the client 110 uses one or more alternative connections 106 to send troubleshooting information, such as an alternative connection 106 identified via the information the client 110 received in operation 504 or operation 510. For example, the client 110 can send alternative communications troubleshooting frame 300 to the AP 102. The AP 102 can send troubleshooting information to one or more network devices 120 in operation 514. For example, the AP 102 sends a network management platform the information the AP 102 received in operation 512 and/or information associated with the connection issue the AP 102 collected. The AP 102 may send the troubleshooting information via the wireless network connection 104 if the connection issue does not prevent the AP 102 from doing so and/or via one or more alternative connections 106. In other embodiments, the AP 102 may diagnose and repair the connection issue itself instead of forwarding the troubleshooting information to the network devices 120.

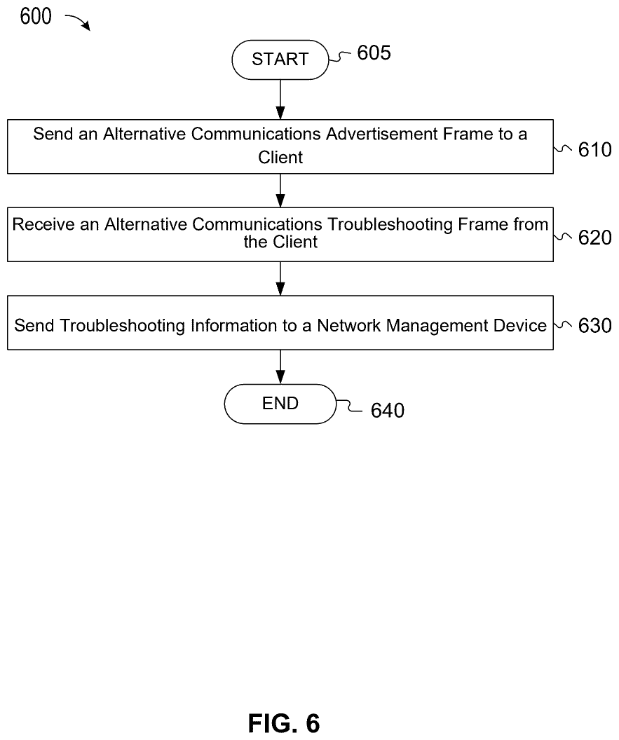

FIG. 6 is a flow chart of a method 600 for supporting alternative communications techniques for troubleshooting. The method 600 can begin at starting block 605 and proceed to operation 610. In operation 610, an alternative communications advertisement frame is sent to a client. For example, the AP 102 sends an alternative communications advertisement frame 200 to the client 110. The alternative communications advertisement frame 200 can identify an alternative connection for communicating with the client 110 as described above. In some embodiments, the alternative communications advertisement frame 200 also indicates an address of a device for connection issue reporting (e.g., so the client 110 can communicate with a network device 120 via the direct connection 130).

In operation 620, an alternative communications troubleshooting frame is received from the client via the alternative connection. For example, the AP 102 receives an alternative communications troubleshooting frame 300 from the client 110 via the alternative connections 106. The alternative communications troubleshooting frame 300 can include troubleshooting information associated with a connection issue of a wireless network (e.g., the wireless network connection 104). The alternative communications troubleshooting frame 300 can include the timestamp field 310, the status code field 312, the troubleshooting information field 314, and/or the like, all containing troubleshooting information for the connection issue.

In operation 630, the troubleshooting information is sent to a network device. For example, the AP 102 sends the troubleshooting information received from the client 110 and/or information the AP 102 collected to one or more of the network devices 120. The one or more network devices 120 can then diagnose, determine how to fix, and/or fix the connection issue. The one or more network devices 120 may send troubleshooting correction information to the AP 102 and/or the client 110 detailing how to restore the client's 110 connection to the wireless network via the wireless network connection 104. The AP 102 and/or the client 110 can perform actions to restore the connection based on the troubleshooting correction information. The method 600 can also comprise sending to the client an address of a device for connection issue reporting. For example, the AP 102 sends an address of a device of the network devices 120, so the client 110 can communicate with the device via the direct connection 130.

In some embodiments, the AP 102 receives an alternative communications request frame 400 from the client 110, wherein sending the alternative communications advertisement frame 200 is in response to receiving the alternative communications request frame 400. The alternative communications request frame 400 can include a connection issue notification field 410, a client supported alternative communications field 412, and/or the like. The method 600 can conclude at ending block 640.

FIG. 7 is a block diagram of a computing device 700. As shown in FIG. 7, computing device 700 may include a processing unit 710 and a memory unit 715. Memory unit 715 may include a software module 720 and a database 725. While executing on processing unit 710, software module 720 may perform, for example, processes for supporting alternative communications techniques for troubleshooting connection issues with respect to FIG. 1, FIG. 2, FIG. 3, FIG. 4, FIG. 5, and FIG. 6.

Computing device 700, for example, may provide an operating environment for the AP 102, the client 110, the network devices 120, and the like. The AP 102, the client 110, the network devices 120, and the like may operate in other environments and are not limited to computing device 700.

Computing device 700 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 700 may comprise any computer operating environment, such as hand-held devices, multiprocessor systems, microprocessor-based or programmable sender electronic devices, minicomputers, mainframe computers, and the like. Computing device 700 may also be practiced in distributed computing environments where tasks are performed by remote processing devices. The aforementioned systems and devices are examples, and computing device 700 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 700 on the single integrated circuit (chip).

FIG. 8 illustrates an implementation of a communications device 800 that may implement one or more of the AP 102, the client 110, the network devices 120, etc., of FIGS. 1-6. In various implementations, the communications device 800 may comprise a logic circuit. The logic circuit may include physical circuits to perform operations described for one or more of the AP 102, the client 110, the network devices 120, etc., of FIGS. 1-6, for example. As shown in FIG. 8, the communications device 800 may include one or more of, but is not limited to, a radio interface 810, baseband circuitry 830, and/or the computing device 700.

The communications device 800 may implement some or all of the structures and/or operations for the AP 102, the client 110, the network devices 120, etc., of FIGS. 1-6, storage medium, and logic circuit in a single computing entity, such as entirely within a single device. Alternatively, the communications device 800 may distribute portions of the structure and/or operations using a distributed system architecture, such as a client station server architecture, a peer-to-peer architecture, a master-slave architecture, etc.

A radio interface 810, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 810 may include, for example, a receiver 815 and/or a transmitter 820. The radio interface 810 may include bias controls, a crystal oscillator, and/or one or more antennas 825. In additional or alternative configurations, the radio interface 810 may use oscillators and/or one or more filters, as desired.

The baseband circuitry 830 may communicate with the radio interface 810 to process, receive, and/or transmit signals and may include, for example, an Analog-To-Digital Converter (ADC) for down converting received signals with a Digital-To-Analog Converter (DAC) 835 for up converting signals for transmission. Further, the baseband circuitry 830 may include a baseband or PHYsical layer (PHY) processing circuit for the PHY link layer processing of respective receive/transmit signals. Baseband circuitry 830 may include, for example, a MAC processing circuit 840 for MAC/data link layer processing. Baseband circuitry 830 may include a memory controller for communicating with MAC processing circuit 840 and/or a computing device 700, for example, via one or more interfaces 845.

In some configurations, PHY processing circuit may include a frame construction and/or detection module, in combination with additional circuitry such as a buffer memory, to construct and/or deconstruct communication frames. Alternatively or in addition, MAC processing circuit 840 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
sending an alternative communications advertisement frame to a client, the alternative communications advertisement frame identifying an alternative connection for communicating with the client;
receiving an alternative communications troubleshooting frame from the client via the alternative connection, the alternative communications troubleshooting frame comprising troubleshooting information associated with a connection issue of a wireless network; and
sending the troubleshooting information to a network device.

2. The method of claim 1, further comprising sending to the client an address of a device for connection issue reporting.

3. The method of claim 1, further comprising receiving from the client an alternative communications request frame, wherein sending the alternative communications advertisement frame is in response to receiving the alternative communications request frame.

4. The method of claim 3, wherein the alternative communications request frame comprises any one of (i) a connection issue notification field for indicating the connection issue exists, (ii) a client supported alternative communications field to indicate one or more client supported communication methods, or (iii) both (i) and (ii), wherein the one or more client supported communication methods includes the alternative connection.

5. The method of claim 1, wherein the alternative communications advertisement frame comprises any one of (i) a supported alternative communications field indicating one or more supported alternative communications methods including the alternative connection, (ii) a reporting address field including an address of a device for connection issue reporting, or (iii) both (i) and (ii).

6. The method of claim 1, wherein the alternative communications troubleshooting frame comprises any one of (i) a timestamp field indicating a time the connection issue began, (ii) a status code field indicating a status code associated with the connection issue, (iii) a troubleshooting information field including additional troubleshooting information, or (iv) any combination of (i)-(iii).

7. The method of claim 1, further comprising:
receiving troubleshooting correction information from the network device; and
restoring a connection to the client using the troubleshooting correction information.

8. A system comprising:
a memory storage; and
a processing unit coupled to the memory storage, wherein the processing unit is operative to:
send an alternative communications advertisement frame to a client, the alternative communications advertisement frame identifying an alternative connection for communicating with the client;
receive an alternative communications troubleshooting frame from the client via the alternative connection, the alternative communications troubleshooting frame comprising troubleshooting information associated with a connection issue of a wireless network; and
send the troubleshooting information to a network device.

9. The system of claim 8, the processing unit being further operative to send to the client an address of a device for connection issue reporting.

10. The system of claim 8, the processing unit being further operative to receive from the client an alternative communications request frame, wherein to send the alternative communications advertisement frame is in response to receiving the alternative communications request frame.

11. The system of claim 10, wherein the alternative communications request frame comprises any one of (i) a connection issue notification field for indicating the connection issue exists, (ii) a client supported alternative communications field to indicate one or more client supported communication methods, or (iii) both (i) and (ii), wherein the one or more client supported communication methods includes the alternative connection.

12. The system of claim 8, wherein the alternative communications advertisement frame comprises any one of (i) a supported alternative communications field indicating one or more supported alternative communications methods including the alternative connection, (ii) a reporting address field including an address of a device for connection issue reporting, or (iii) both (i) and (ii).

13. The system of claim 8, wherein the alternative communications troubleshooting frame comprises any one of (i) a timestamp field indicating a time the connection issue began, (ii) a status code field indicating a status code associated with the connection issue, (iii) a troubleshooting information field including additional troubleshooting information, or (iv) any combination of (i)-(iii).

14. The system of claim 8, the processing unit being further operative to:
receive troubleshooting correction information from the network device; and
restore a connection to the client using the troubleshooting correction information.

15. A non-transitory computer-readable medium that stores a set of instructions which when executed perform a method executed by the set of instructions comprising:
sending an alternative communications advertisement frame to a client, the alternative communications advertisement frame identifying an alternative connection for communicating with the client;
receiving an alternative communications troubleshooting frame from the client via the alternative connection, the alternative communications troubleshooting frame comprising troubleshooting information associated with a connection issue of a wireless network; and
sending the troubleshooting information to a network device.

16. The non-transitory computer-readable medium of claim 15, the method executed by the set of instructions further comprising sending to the client an address of a device for connection issue reporting.

17. The non-transitory computer-readable medium of claim 15, the method executed by the set of instructions further comprising receiving from the client an alternative communications request frame, wherein sending the alternative communications advertisement frame is in response to receiving the alternative communications request frame.

18. The non-transitory computer-readable medium of claim 17, wherein the alternative communications request frame comprises any one of (i) a connection issue notification field for indicating the connection issue exists, (ii) a client supported alternative communications field to indicate one or more client supported communication methods, or (iii) both (i) and (ii), wherein the one or more client supported communication methods includes the alternative connection.

19. The non-transitory computer-readable medium of claim 15, wherein the alternative communications advertisement frame comprises any one of (i) a supported alternative communications field indicating one or more supported alternative communications methods including the alternative connection, (ii) a reporting address field including an address of a device for connection issue reporting, or (iii) both (i) and (ii).

20. The non-transitory computer-readable medium of claim 15, wherein the alternative communications troubleshooting frame comprises any one of (i) a timestamp field indicating a time the connection issue began, (ii) a status code field indicating a status code associated with the connection issue, (iii) a troubleshooting information field including additional troubleshooting information, or (iv) any combination of (i)-(iii).
